(19) United States
(12) Patent Application Publication
(10) Pub. No.: US 2016/0034570 A1
(43) Pub. Date: Feb. 4, 2016

(54) CREATING ASSOCIATIONS TO A SERVICE SUBSCRIBER

(71) Applicant: TELEFONAKTIEBOLAGET L M ERICSSON (PUBL), Stockholm (SE)

(72) Inventors: Rickard COSTER, Hägersten (SE); Subramanian SHIVASHANKAR, Chennai (IN); Mona MATTI, Nacka (SE)

(73) Assignee: Telefonaktiebolaget L M Ericsson (publ), Stockholm (SE)

(21) Appl. No.: 14/784,274

(22) PCT Filed: Apr. 17, 2013
(86) PCT No.: PCT/SE2013/050417

§ 371 Date: Oct. 13, 2015

(51) Int. Cl. G06F 17/30; H04L 29/12; G06Q 30/02

(52) U.S. Cl. CPC G06F 17/30707; G06F 17/30663; G06Q 30/0282; H04L 61/6054; H04L 61/35

(57) ABSTRACT

Creating an association between an identity of a telecommunication service subscriber and one or more reviews related to a telecommunication operator providing the service, wherein one or more review values and one or more subscriber features are assigned to one or more defined review topic.

### TECHNICAL FIELD

The invention relates to methods for creating an association between an identity of a telecommunication service subscriber and one or more reviews related to the telecommunication operator providing the service. The invention also relates to a network node connectable to a network of a telecommunication operator and arranged to create an association between an identity of a telecommunication service subscriber and one or more reviews related to the telecommunication operator providing the service.

### BACKGROUND

A User Equipment (UE), such as e.g. a cellular phone, is typically connected to an operator/service provider in order to access telecommunication services offered by the operator, and the operator charges the owner of the UE, i.e. the end-user/subscriber, for the services. If the end-user is not satisfied with the services, he/she may decide to churn, i.e. end his/her subscription and switch to another operator. Churning may be predicted by the operator e.g. from the call rate from a User Equipment, and such information can be retrieved from the Call Detail Record (CDR) of the operator. The CDR comprises records generated by the charging system for every operation performed by a user/subscriber, and the information may be extracted and analyzed e.g. in order to predict churning.

A churning may be prevented e.g. by targeted offers from the operator to the end-user. In order to provide targeted offers and improve the services, for example for preventing the above-described churning, a telecommunication operator may obtain opinions or reviews related to the services offered by the operator, e.g. using social media analysis, or by polling of selected groups of customers. Such reviews provide a valuable feedback for the operator.

Social media analysis typically includes opinion mining regarding various products/topics of interest, such as e.g. opinions expressed on Internet web-pages regarding telecommunication services and products offered by different telecommunication operators.

Thus, a telecommunication operator is able to obtain opinions and reviews regarding its products and services using e.g. the above-mentioned social media analysis, or other appropriate methods. However, the operator typically has no information of the identity of a person expressing the opinion or review, and does not even know if the reviews are expressed by a person subscribing to a service offered by the operator, by a previous subscriber that has already churned, or maybe by a person that has never subscribed to a service offered by the operator.

### SUMMARY

It is an object of embodiments of this invention to address at least some of the issues outlined above, and this object and others are achieved by the method and the network node according to the appended independent claims, and by the embodiments according to the dependent claims.

A first aspect of the embodiments provides a method for creating an association between an identity of a telecommunication service subscriber and one or more reviews related to a telecommunication operator providing the service. The method comprises:
assigning, for each review, one or more review values to one or more defined topics;
assigning one or more subscriber features to each of said one or more defined topics;
retrieving, for one or more identities, a feature value associated with one or more subscriber features, wherein the feature values are retrieved from a first memory connected to a network node of the operator;
for each topic, combining the retrieved feature values of the assigned subscriber features related to each identity;
for each of said one or more identities, combining a value indicating a relationship to each one or more defined topics with a value indicating a relationship between each of said one or more defined topics and each one or more review values.

A second aspect of the embodiments provides a network node connectable to network of a telecommunication operator and arranged to create an association between an identity of a telecommunication subscriber and one or more reviews related to the operator providing the service. The network node comprises receiving circuitry, transmitting circuitry, and processing circuitry, wherein the network node is configured to:
assign, for each review, one or more review values to one or more defined topics;
assign one or more subscriber features to each of said one or more defined topics;
retrieve, for one or more identities, a feature value associated with each subscriber feature, wherein the feature values are retrieved from a first memory connected to the network node;
combine, for each topic, the retrieved feature values of the assigned subscriber features related to each identity;
combine, for each of said one or more identities, a value indicating a relationship to each one or more defined topics with a value indicating a relationship between each of said one or more defined topics and each of said one or more review values.

A third aspect of the embodiments provides a computer program comprising computer readable code which when run on a network node causes the network node to perform a method comprising at least the steps of the first aspect.

A fourth aspect provides a computer program product comprising the computer program according the third aspect being stored on a computer readable medium.

An advantage with obtaining associations between subscriber identities and reviews, e.g. online reviews, is to provide information related to the opinion of particular users regarding products or services, and also regarding which user groups that dislike or like particular aspects of the services. This information may be used e.g. to improve or personalize products and services and to find target groups for campaigns. Further, an enriched segmentation and characterization of subscribers, products and services is enabled.

### BRIEF DESCRIPTION OF THE DRAWINGS

The present invention will be described in more detail below, and with reference to the accompanying figure, of which:

FIG. 1 is a block diagram illustrating an exemplary architecture of a telecommunication operator network;

FIGS. 2a, 2b and 2c illustrates the relationship between subscribers and reviews using matrices;

FIG. 3 is a flow diagram schematically illustrating an exemplary method for creating an association between subscribers and reviews related to a telecommunication operator;

FIGS. 4a and 4b are block diagrams schematically illustrating an exemplary network node connectable to a telecommunication operator network.

### DETAILED DESCRIPTION

In the following, the invention will be described in more detail, with reference to accompanying drawings. For the purpose of explanation and not limitation, specific details are disclosed, such as particular scenarios and techniques, in order to provide a thorough understanding.

Moreover, it is apparent that the exemplary method and network node described below may be implemented, at least partly, by the use of software functioning in conjunction with a programmed microprocessor or general purpose computer, and/or using an application specific integrated circuit (ASIC). Further, the embodiments may also, at least partly, be implemented as a computer program product or in a system comprising a computer processor and a memory coupled to the processor, wherein the memory is encoded with one or more programs that may perform the functions disclosed herein.

A telecommunication operator may obtain opinions and reviews regarding its products and services using e.g. social media analysis. However, the reviews are not linked to any individual end-user/subscriber. In order to provide such a link, the embodiments described hereinafter may use e.g. the operator's own assets and network data for creating associations between reviews related to services of a telecommunication operator and individual end-users subscribing to a service offered by the operator.

In order to create the associations, embodiments described hereinafter combines data related to the subscribers, such as e.g. their usage, with data related to reviews of operator's products and services, thereby creating a link between end-users and reviews. For enabling the combining, a set of topics are defined for the reviews, such as e.g. “Coverage”, “Local calls”, “International calls”, and a set of features related to subscriber are defined, such as e.g. “Complaints”, “Local usage”, “International usage”. The topics and the features are defined such that an inherent relationship exists between them. Each topic is related to at least some of the features, e.g. the feature “International usage” is related to the topic “International calls”, and the feature “Local calls” is related to the topic “Local usage”. Based on this relationship between the review topics and one or more subscriber features, the topics and the features can be used as a bridge between the data related to the subscribers and data related to the reviews.

Thus, in order to associate individual subscribers/end-users with reviews, according to embodiments, features are defined that are related to the telecommunication subscriber, and topics are defined that are related to reviews of the services of telecommunication operator, and a relationship exists between the topics and the features. Based on this relationship, one or more subscriber features are assigned to each topic, and a topic is expressed as a function of one or more subscriber features.

Table 1 below is a listing of exemplary subscriber features, denoted F1-F18, and Table 2 below is a listing of exemplary topics denoted G1-G10:

TABLE 1
Subscriber features (F1-F18)

| | |
|---|---|
| F1 | Plan |
| F2 | City |
| F3 | Complaints |
| F4 | Local usage |
| F5 | Nationwide usage |
| F6 | International usage |
| F7 | Number of calls |
| F8 | Number of SMS |
| F9 | Call change k days |
| F10 | SMS change k days |
| F11 | Life in network |
| F12 | Churn value |
| F13 | Upselling value |
| F14 | Appetency value |
| F15 | Node positions |
| F16 | Role measures |
| F17 | Refills |
| F18 | Call quality index |

TABLE 2
Review topics (G1-G10)

| | |
|---|---|
| G1 | Plan |
| G2 | City |
| G3 | Score overall |
| G4 | Score for local calls |
| G5 | Score for nationwide calls |
| G6 | Score for international calls |
| G7 | Score for SMS |
| G8 | Score for coverage |
| G9 | Score for customer care |
| G10 | Score for billing |

An exemplary listing of the features in Table 1 that are related to each topic in Table 2 is indicated in Table 3 below:

TABLE 3
Subscriber features (F1-F18) related to each topic (G1-G10)

| | |
|---|---|
| G1 | F1 |
| G2 | F2 |
| G3 | F3, F11, F12, F13, F14, F17, F18 |
| G4 | F3, F4, F9, F11, F12, F17, F18 |
| G5 | F3, F5, F7, F9, F11, F12, f17, f18 |
| G6 | F3, F6, f7, F9, f11, fF12, f18 |
| G7 | F8, F10, F11, F17 |
| G8 | F3, F11, F12, F18 |
| G9 | F3, F11, F12 |
| G10 | F3, F11, F12, F17 |

Table 3 above should be interpreted as though, for example, the topic G3 (“Score overall”) is related to the subscriber features F3, F11, F12, F13, F14, F17 and F18, i.e. to the features “Complaints”, “Life in network”, “Churn value”, “Upselling value”, “Appetency value”, “Refills” and “Call quality index”. This relationship may e.g. be expressed as a linear combination of the subscriber features that are related to each topic, or a combination in which each subscriber feature is weighted, and the Topic may be expressed as a function of the related features. A weighted function may be illustrated e.g. by the topic G6, “Score for international calls”, in Table 3, which is related to the features F3—Complaints, F6—International Usage, F7—Number of calls, F9—Call change last k days, F11—Life in network, F13—Churn Value and F18—Call quality Index. A weighted function may be expressed as: G6=w₃F3+w₆F6+w₇F7+w₁₁F11+w₁₃F13+w₁₈F18, wherein the weights w₃, w₆, w₇, w₁₁, w₁₃, w₁₈, are set heuristically or by analyzing poll results or both. In order to ensure values in the range [−1,+1] the values may be normalized.

Thus, according to an embodiment, a heuristic weighting of each feature is performed depending on each topic. According to another embodiment, a subset of subscribers is polled for their opinion regarding each topic, and the subscriber features are weighted based on their answers.

In order to find reviews and opinions related to the defined topics, reviews published e.g. on Internet web-pages could be mined for opinions related to the defined topics. The mining may involve any suitable conventional technique, such as e.g. a so-called Sentiment Analysis, which is a computational study of opinions, sentiments, subjectivity, evaluations, attitudes, appraisal, affects, views or emotions that is expressed in a text. In order to determine a review value in a review expressed in the text, it could e.g. be determined to which degree a review is positive, negative or neutral regarding the service of the operator, such e.g. the call quality, the price plan and the international calls.

In order to clarify and explain an exemplary use of sentiment analysis in embodiments of our invention, the topic “Score for international calls” is defined, and the higher the score, the more positive the review is in using the operator for making international calls. Using sentiment analysis of the review that is analyzed, a value is assigned for this topic, the value being a subjective value related to the score for international calls. If the text for example would contain the phrase “International calls are too expensive”, this would indicate e.g. the review value Low for the topic “Score for international calls”, and also the review value Low for a topic defined as “Score for price plan”. If it cannot be determined from the text whether the review is positive or negative regarding a defined topic, the review value could e.g. be set to Neutral.

Further, according to embodiments described hereinafter, data regarding the subscribers are mined in order to extract data related to the subscriber features, i.e. feature values. The subscriber features may be conventional telecommunication features, and the feature values could be extracted from operator assets and/or from network data, such as e.g. from the CDR, the user profile, and the KPI (Key Performance Indicators). Thus, according to embodiments, feature values related to each subscriber is combined for each topic, using an above-described relationship between the subscriber features and the topics, wherein a value indicating the strength of the relationship between each subscriber identity and each defined topic is obtained.

When a relationship has been created between each subscriber identity and each defined topic, and a suitable analysis has been performed for creating a relationship between each defined topic and review values, a link exists between individual subscriber identities and the review values. According to embodiments of the invention, a relationship between each subscriber identity and each topic and a relationship between each topic and each review value is combined in order to establish an association between the subscriber identities and the reviews. This association may e.g. be expressed as a matrix indicating values for the relationship between each subscriber identity and each review value. This user/review-relationship could also be a link to the full content of some of the reviews, which also contain aspects that are not linked to any subscriber identity.

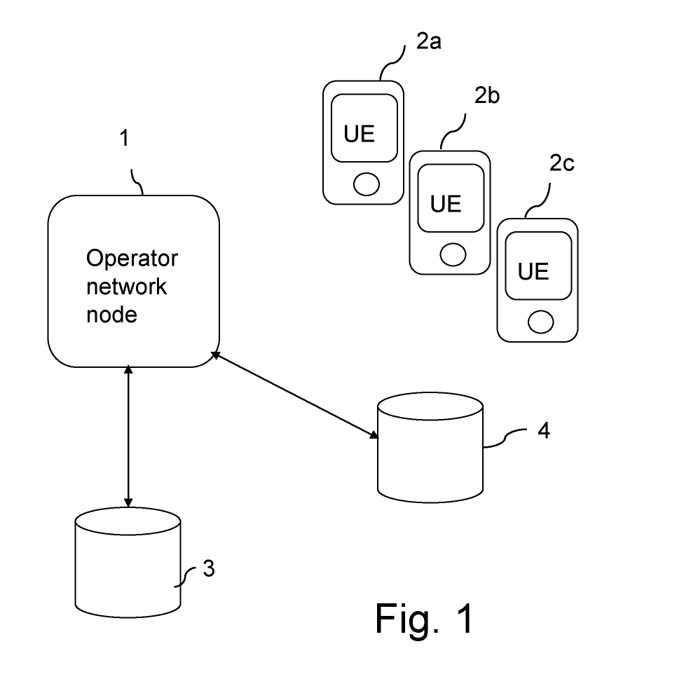

FIG. 1 illustrates an exemplary architecture of an operator's network, comprising a network node 1, a first memory 3 and a second memory 4, and three user equipments 2a, 2b, 2c, which are subscribing to services of the operator. The operator's assets and network data that are utilized in order to extract subscriber data are retrieved from the first memory 3, and the resulting user/review-relationship is stored in the second memory 4.

According to an embodiment, the method is performed by a network node belonging to the operator. However, according to another embodiment, the method is performed externally, and the result is provided to the operator.

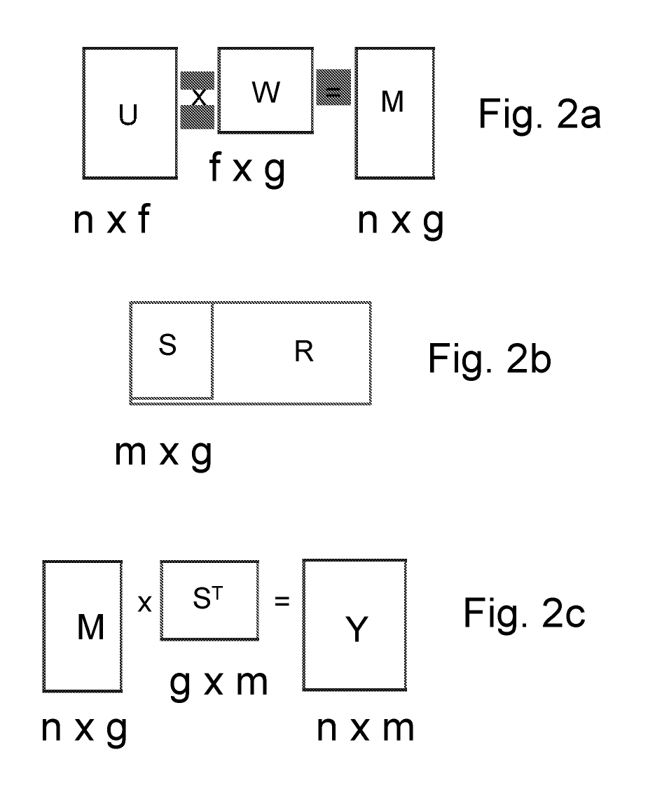

FIGS. 2a, 2b and 2c uses matrices in order to explain an embodiment of the method, wherein the strength of the relationship between users and reviews is described by a matrix Y (in FIG. 2c) of n users and m reviews where the matrix entry (i,j) denote the approximate strength of relationship between, or rating of, review j and (by) user i. The matrices are used for describing the embodiment in order to clarify how the relationship between topics, reviews, features and user identities are utilized for creating an association between a subscriber identity and a review.

In FIG. 2a, the matrix U is a matrix indicating the strength of the relationship between each of n users and each of f features, and matrix U is hereinafter denoted a user/feature matrix. Matrix W is a matrix indicating the strength of the relationship between each one of f features and each one of g defined topics, and matrix W is hereinafter denoted a feature/topic matrix. In order to associate one or more subscriber identities (users) with one or more reviews, the matrix U is multiplied with matrix W, resulting in a new matrix M, which indicates the strength of the relationship between each one of n users and each one of g topics. Thus, matrix M is hereinafter denoted a user/topic matrix. The values in matrix M may be normalized in the range [−1, +1] where −1 is negative, zero is neutral and +1 is positive.

For the reviews, matrix S in FIG. 2b indicates the strength of the relationship between each one of m reviews and each one of the g defined topics, and matrix S is hereinafter denoted a review/topic matrix. However, the reviews may also contain additional relevant information and subjective opinions, which are not related to any of the g defined topics. For this reason, a larger matrix R defines the relationship between said m features and (g+k) topics, wherein matrix S in included in matrix R. Thus, m reviews related to the g defined topics are included in matrix S, and an additional k (undefined) topics are included only in matrix R. The values in matrix S may also be normalized in the same way as the values in matrix M.

FIG. 2c illustrates that the user/topic matrix M is multiplied with the topic/review-matrix S^{T}, which corresponds to the transposed review/topic-matrix S. This multiplication results in the desired user/review-matrix Y. The entry (i,j) in Y is thus the result of multiplying the row vector i in M by column vector j of S^{T}, which effectively provides a weighted sum for each review for each user. However, some of these values may be zero, e.g. if a review has very few topics that could be analyzed and/or the features from the telecom data did not give a strong enough signal regarding the topics.

However, since the obtained strength of the relationship between subscriber identities, i.e. users, and the reviews relies e.g. on heuristics and/or customer polls, and the reviews could be biased and not contain all information that is needed, the result is preferably analyzed by suitable algorithms, e.g. algorithms based on dimensionality reduction and/or clustering.

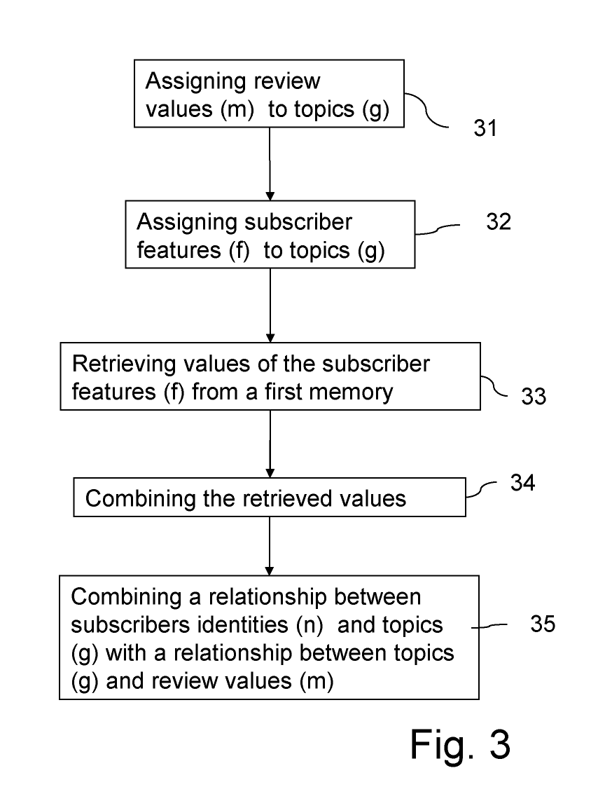

FIG. 3 is a flow diagram schematically illustrating an exemplary method for creating an association between an identity of a subscriber and one of more reviews related to an operator. First, one or more review values, m, for each review are assigned to one or more defined topics, g, in step 31, (which may be indicated by the review/topic matrix S), and one or more subscriber features, f, are also assigned to each topic, g, in step 32, (which may be indicated e.g. by the feature/topic matrix W). Next, a feature value is retrieved, in step 33, from a first memory for each subscriber feature, f, for one or more subscriber identities, u, (which may be indicated e.g. by the user/feature matrix U). Further, for each defined topic, g, the retrieved feature values related to each subscriber identity, u, of the subscriber features, f, assigned to the topic are combined, in step 34, (which may be indicated e.g. by the user/topic matrix M). Next, for each one or more subscriber identities, u, the relationship to each defined topic, g, is combined 35 with the relationship between each topic, g, and each review value, m, (which may be indicated e.g. by a multiplication of the user/topic matrix M and the topic/review matrix S^{T}, and which results in the desired association between the subscriber identities, u, and the review values, (which may be indicated e.g. by the user/review matrix Y).

Said feature values are retrieved from the first memory 3 e.g. by the network node 1, using for example a conventional SIP request or HTTP get, depending on the architecture.

According to a further embodiment of the method, values indicating a relationship between said one or more subscriber identities and said one or more review values are stored in a second memory 4 connected to the network node 1 of the operator. Further, according to an embodiment, each subscriber feature is weighted for a defined topic in the combining 34 of the retrieved feature values related to each subscriber identity.

According to a further embodiment, the weight of each subscriber feature is determined heuristically or by polling a subset of subscribers.

According to an embodiment, sentiment analysis is used for assigning one or more reviews values for each review to one of more defined topics.

According to a still further embodiment of the method, the combining 35 of a value indicating a relationship between one or more subscriber identities and each one or more defined topics, with a value indicating a relationship between said one or more defined topic and each of one or more review values comprises:
multiplying the values of a matrix M indicating a relationship between one or more subscriber identities and one or more defined topics, with the values of a matrix S^{T} indicating a relationship between said one or more defined topics and one or more review values, and
obtaining a matrix Y wherein the values indicate a relationship between each of said one or more subscriber identities and each of said one or more review values.

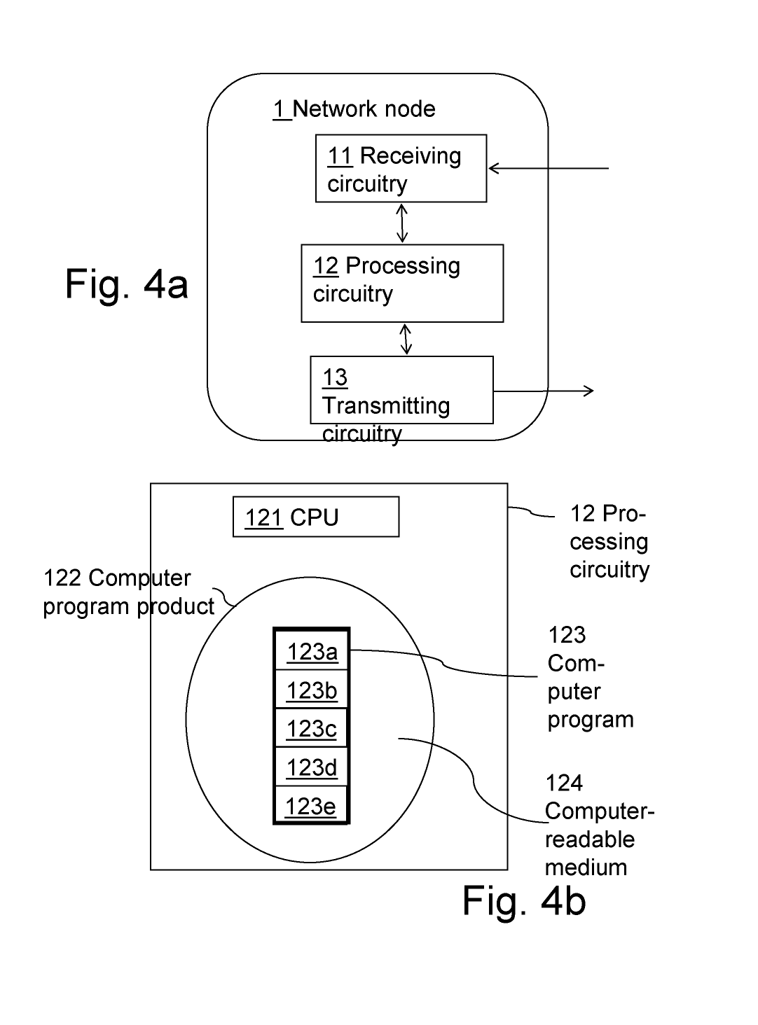

FIG. 4a illustrates schematically an exemplary network node 1 that is connectable to the network of a telecommunications operator, and is arranged to create an association between an identity of a service subscriber and one or more reviews related to the operator. The network node comprises receiving circuitry 11, transmitting circuitry 13, and processing circuitry 12, wherein the network node is configured to assign one or more review values, m, for each review to or more defined topics, g, and to also assign one more subscriber features, f, to each topic, g. Further, it is apparent that the network node also comprises other appropriate hardware. The network node is also configured to retrieve a feature value from a first memory 3 for each subscriber feature, f, for one or more subscriber identities, u. For each defined topic, g, the network node is configured to combine the retrieved feature values related to each subscriber identity, u, of the subscriber features, f, assigned to the topic. The network node is further configured to combine the relationship between each one or more subscriber identities, u, and each defined topic, g, with the relationship between each topic, g, and each review value, m, which results in the desired association between the subscriber identities, u, and the reviews.

According to a further embodiment of the network node, it is arranged to store, in a second memory 4 connected to the network node, values indicating a relationship between said one or more subscriber identities and each of said one or more review values. According to an embodiment, the network node is arranged to weight each subscriber feature for each defined topic in the combining of the retrieved feature values related to each subscriber identity.

According to alternative embodiments, the weight of each subscriber feature is determined heuristically or by polling a subset of subscribers.

According to an embodiment of the network node, sentiment analysis is used for assigning one or more reviews values for each review to one of more defined topics.

According to a further embodiment of the network node, the processing circuitry is configured to:
multiply values of a matrix M indicating a relationship between one or more subscriber identities and one or more defined topics, with values of a matrix S^{T} indicating a relationship between said one or more defined topics and one or more review values, and
obtain a matrix Y wherein the values indicate a relationship between each of said one or more subscriber identities and each of said one or more review values.

FIG. 4b schematically illustrates an embodiment of the processing circuitry 12 illustrated in FIG. 4a. The processing circuitry in FIG. 4b comprises a CPU 121, which may be a single unit or a plurality of units. Furthermore, the processing circuitry comprises at least one computer program product 122, in the form of a non-volatile memory, e.g. an EEPROM (Electrically Erasable Programmable Read-Only Memory), a flash memory or a disk drive. The computer program product 122 includes a computer readable medium 124 provided with a computer program 123, which comprises computer readable coded instructions 123a-123e, which when run on the network node causes the CPU 121 to perform at least the steps illustrated in FIG. 3.

Thus, in the exemplary embodiment illustrated in FIG. 4b, the computer readable coded instructions in the computer program 123 comprises a review to topics-assigning module 123a, a feature to topic-assigning module 123b, a feature value-retrieving module 123c, a feature value-combining module 123d, and a relationship-combining value 123e, which interact with the hardware in the network node in order to perform at least the steps of the flow in FIG. 3.

However, the entities and units described above with reference to the figures are mainly logical units, which do not necessarily correspond to separate physical units.

Furthermore, the above mentioned and described embodiments are only given as examples and should not be limiting to the present invention. Other solutions, uses, objectives, and functions within the scope of the invention as claimed in the accompanying patent claims should be apparent for the person skilled in the art.

1. A method for creating an association between an identity of a telecommunication service subscriber and one or more reviews related to a telecommunication operator providing the service, the method comprising:
assigning, for each review, one or more review values to one or more defined topics;
assigning one or more subscriber features to each of said one or more defined topics;
retrieving, for one or more identities, a feature value associated with one or more subscriber features, wherein the feature values are retrieved from a first memory connected to a network node of the operator;
for each topic, combining the retrieved feature values of the assigned subscriber features related to each identity; and
for each of said one or more identities, combining a value indicating a relationship to each one or more defined topics with a value indicating a relationship between each of said one or more defined topics and each one or more review values.

2. The method according to claim 1, further comprising storing, in a second memory connected to the network node of the operator, values indicating a relationship between said one or more identities and said one or more review values.

3. The method according to claim 1 further comprising weighting each subscriber feature for each defined topic in the combining of the retrieved feature values related to each identity.

4. The method according to claim 3, wherein a weight Of each subscriber feature is determined heuristically or by polling a subset of subscribers.

5. The method according to claim 1, wherein a sentiment analysis is used for assigning, for each review, one or more review values to one or more defined topics.

6. The method according to claim 1, wherein the combining of a value indicating a relationship between one or more identities and each one or more defined topics, with a value indicating a relationship between said one or more defined topics and each of one or more review values, comprises:
multiplying the values of a matrix indicating a relationship between One or more identities and one or more defined topics, with the values of a matrix indicating a relationship between said one or more defined topics and one or more review values, and
obtaining a matrix, of which the values indicate a relationship between each of said one or more identities and each of said one or more review values.

7. A network node connectable to network of a telecommunication operator and arranged to create an association between an identity of a telecommunication subscriber and one or more reviews related to the operator providing the service, the network node comprising:
receiving circuitry, transmitting circuitry, and processing circuitry, wherein the processing circuitry is configured to:
assign, for each review, one or more review values to one or more defined topics;
assign one or more subscriber features to each Of said one or more defined topics;
retrieve, for one or more identities, a feature value associated with each subscriber feature, wherein the feature values are retrieved from a first memory connected to the network node;
combine, for each topic, the retrieved feature values of the assigned subscriber features related to each identity; and
combine, for each of said one or more identities, a value indicating a relationship to each one or more defined topics with a value indicating a relationship between each of said one or more defined topics and each of said one or more review values.

8. The network node according to claim 7, wherein the processing circuitry is further configured to store, in a second memory connected to the network node, values indicating a relationship between said one or more identities and each of said one or more review values.

9. The network node according to claim 7, wherein the processing circuitry is further configured to weight each subscriber feature for each defined topic in the combining of the retrieved feature values related to each identity.

10. The network node according to claim 7, wherein a weight of each subscriber feature is determined heuristically or by polling a subset of subscribers.

11. The network node according to claim 7, wherein sentiment analysis is used for assigning, for each review, one or more review values to one or more defined topics.

12. The network node according to claim 7, wherein the processing circuitry is configured to:
multiply values of a matrix M indicating a relationship between one or more identities and one or more defined topics, with values of a matrix ST indicating a relationship between said one or more defined topics and one or more review values, and
obtain a matrix Y wherein the values indicate a relationship between each of said one or more identities and each of said one or more review values.

13. A computer program product comprising a non-transitory computer readable storage medium storing computer program code which, when run on a network node, causes the network node to perform the method as claimed in claim 1.

14. (canceled)
